(19) United States
(12) Patent Application Publication
(10) Pub. No.: US 2015/0346017 A1
(43) Pub. Date: Dec. 3, 2015

(54) FLUID VOLUMETRIC ANALYZER

(71) Applicants: Daniel Slomski, (US); Tachyus Corporation, San Mateo, CA (US)

(72) Inventors: Francisco LePort, San Francisco, CA (US); Lucas Allen, San Mateo, CA (US); Daniel Slomski, San Francisco, CA (US)

(73) Assignee: TACHYUS CORPORATION, San Mateo, CA (US)

(21) Appl. No.: 14/726,422

(22) Filed: May 29, 2015

Related U.S. Application Data
(60) Provisional application No. 62/005,905, filed on May 30, 2014.

(51) Int. Cl. G01F 23/292; G01F 23/26; E21B 49/10

(52) U.S. Cl. CPC G01F 23/2921; E21B 49/10; G01F 23/263

(57) ABSTRACT

Systems and methods are disclosed for an automatic fluid composition sensor. A fluid composition sensor includes a plurality of detection elements positioned along a length of a sample chamber having a number of material interfaces, the fluid composition sensor detecting location(s) of the interface(s) and/or a composition of one or more of the materials within the chamber. A fluid level sensor generates one or more pulses and measures a time delay between a transmission of the pulses from a source and a reception of the reflected pulses from a gas/oil interface to estimate a position of the oil/gas interface and thus a height of the oil in an oil well.

### CROSS REFERENCE TO RELATED APPLICATIONS

This application claims benefit of U.S. Patent Application No. 62/005,905 filed 30 May 2014, the content of which is hereby expressly incorporated by reference thereto in its entirety for all purposes.

### FIELD OF THE INVENTION

The present invention relates generally to analyzing fluids, and more specifically, but not exclusively, to analyzing separated constituents of a fluid mixture such as a composition of oil produced from an oil well and travelling in a pipe from the oil well to a storage location.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Hydrocarbons such as oil and gas currently provide a significant source of energy that powers the world economy. Reservoirs of hydrocarbons are found deep beneath the earth surface. One way to explore and/or extract the hydrocarbons is through wells. For example, oil companies drill oil wells on land or through the ocean floor to extract oil using pumps placed at the bottom of the wells. To ensure the proper operation of the oil wells, it is important to determine the pressure and the composition of hydrocarbon fluids in the wells. For example, fluid pressure and composition at the bottom of an oil well are critical input parameters in modeling and understanding the evolution of a reservoir during depletion. One way to directly measure fluid pressure in an oil well (down-hole pressure) involves lowering a pressure monitor down-hole. However, this operation is expensive and disruptive to the production of the well. An indirect and more economical way to determine the fluid pressure is to measure the height of fluid in the oil well during a period of time when the pump is not operating. The measured height of the fluid may be used to infer the down hole pressure. Knowledge of the fluid level in an oil well may be critical for another reason during normal pump operations. Oil well pumps are designed to pump liquids. The operating life of a pump may be shortened if the fluid level becomes too low and the pump mechanism entrains air. Conversely, a high fluid level exerts back pressure on the reservoir, reducing the rate at which oil enters the wellbore. An optimal fluid level thus maximizes production efficiency while minimizing pump wear.

Knowledge of the composition of the fluid produced from an oil well is also important. Oil wells extract fluids which are generally a mixture of oil, water, natural gas, and sediment. Knowledge of the ratios of the various constituents provides important clues about the state of the oil reservoir. Conventional ways to measure the level and the composition of fluids in oil wells are labor intensive and time consuming, often requiring disruption to the operations of the oil wells.

What is needed is a system and method for determining composition of a fluid produced from an oil well automatically, economically, and seamlessly.

### BRIEF SUMMARY OF THE INVENTION

Disclosed is a system and method for determining a compositional analysis of a fluid, such as, for example, a level of a fluid produced from an oil well automatically, economically, and seamlessly. The following summary of the invention is provided to facilitate an understanding of some of the technical features related to oil constituent compositional analysis, and is not intended to be a full description of the present invention. A full appreciation of the various aspects of the invention can be gained by taking the entire specification, claims, drawings, and abstract as a whole. The present invention is applicable to other fluids from other industries such as foodstuff and mining, among other industries.

According to one embodiment of the present invention, digital capture of values from a set of detecting elements associated with a volume of a separated sample fluid form a profile of a static, separated, multi-constituent fluid inside a closed chamber of a fluid composition sensor.

According to one embodiment of the present invention, the set of detecting elements may include an array of capacitive electrodes arranged on a non-conductive substrate and associated with the fluid sample.

According to one embodiment of the present invention, a composition sensor includes a series of LEDs and cameras positioned along the length of a chamber. The LEDs and cameras may be tuned to emit and detect the absorption bands of the various constituents of a fluid sample captured in the chamber. After the constituents of the fluid sample achieve separation, optionally aided by heating, the emission spectrum of the LEDs are captured and analyzed to estimate the positions of the interface or boundary between the various constituents of the sample. The composition sensor may determine the ratio of the various components in the fluid sample from the estimate of interface positions.

According to an embodiment of the present invention, an automated fluid composition analyzer may be implemented using a variety of technologies, including, for example, a set of LEDs and cameras or a set of capacitive elements disposed appropriately relative to a chamber containing an analyte (e.g., a fluid to be analyzed).

According to one embodiment of the present invention, an automatic fluid level sensor is provided. The fluid level sensor generates one or more electrical pulses and measures a time delay between the transmission of the electrical pulses from a well head and the reception of the reflected pulses from a gas/oil interface to estimate the position of the oil/gas interface and thus the height of the oil in the oil well.

According to one embodiment of the present invention, a fluid level sensor generates one or more sonic pulses and measures the time delay between the transmission of the sonic pulses from a well head and the reception of the reflected pulses from a gas/oil interface to estimate the position of the oil/gas interface and thus the height of the oil in the oil well.

Some embodiments of the present invention provide a relatively simple concept and sampling technique that is allows for an efficient development cycle and ready acceptance by producers who perform prior art processes for cut analysis.

Embodiments of the present invention may detect volumetric percentage content of multiple constituent fluid materials (e.g., 2, 3, 4, 5, 6, or more constituents including one or more of evolved gas, oil, water, steam, emulsion, sediment). Implementations may be flow-rate and pipe diameter invariant allowing use with multiple pump types and is readily scalable to all pipe sizes.

Some embodiments of the present invention may include simple and practical calibration. For example, a series of sealed tube inserts, with varying known contents, may be placed within an analysis chamber. No pump is required.

Some embodiments of the present invention may be designed to better shed or detect and compensate for films/globs/buildups of, for example, waxes, paraffins, asphaltenes, scale, oxides/rust, and/or deposits on an inner wall of an analysis chamber. For example, use of a multi-point sensing array, environmental control (e.g., temperature control via a heating element), and a flow-through analysis chamber help to eliminate or compensate for oil component residues on interior walls of the analysis chamber.

Some embodiments of the present invention automatically determine an interface position (e.g., a height) of the different interface(s) between adjacent constituents of a partially or wholly separated fluid by mapping to a volumetric value based upon the height referenced against a known location (e.g., a bottom of an analysis chamber). Some implementations may include some compensation for non-uniformity in chamber shape. A correspondence/mapping between height and volume may be calibrated during manufacture or use and, optionally, recalibrated periodically during operation.

In some embodiments of the present invention, use of a detecting array with a separated fluid sample having two or more interfaces between three or more constituents allows formation of the response profile from the detecting array over the length of the sample. Such a response profile allows the plurality of interfaces to be detected automatically in the single separated sample (serially or concurrently depending upon implementation) in contrast to devices that operate on non-separated flows or require manual imprecise measurement of a separated column.

An embodiment of the present invention may use an array of detecting elements applied to a separated fluid sample in a sample chamber, the separated fluid sample having two or more interfaces between three or more constituents, to locate positions of the interfaces along the length of the sample chamber and use those positions to calculate actual volume quantities of each constituent (based on a mapping function relative to an interior of the chamber). In some cases, it may be desirable to know volumetric ratios of the constituents which may be calculated from the total volume of the sample and the individual volumes of the separated constituents. Additionally, a compositional analysis may be performed later knowing volume quantities of each constituent.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

According to one embodiment of the present invention, an automatic fluid level sensor is provided. The fluid level sensor generates one or more electrical pulses and measures the time delay between the transmission of the electrical pulses from a well head and the reception of the reflected pulses from a gas/oil interface to estimate the position of the oil/gas interface and thus the height of the oil in the oil well.

According to one embodiment of the present invention, a fluid level sensor generates one or more sonic pulses and measures the time delay between the transmission of the sonic pulses from a well head and the reception of the reflected pulses from a gas/oil interface to estimate the position of the oil/gas interface and thus the height of the oil in the oil well.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a cross sectional view of a down-hole of an oil well that includes a pump and a fluid level sensor at a wellhead to determine a fluid level in the oil well;

FIG. 2 illustrates a block diagram of the fluid level sensor of FIG. 1;

FIG. 3 illustrates a set of steps of operation of the fluid level sensor of FIG. 1 to estimate the fluid level in the oil well;

FIG. 4 illustrates a cross-sectional view of a cut sensor and a fluid composition analyzer used to determine a composition and a ratio of components of a fluid from an oil well;

FIG. 5 illustrates a block diagram of the fluid composition analyzer of FIG. 4;

FIG. 6 illustrates a composition analysis process for estimation of a composition of fluid from an oil well;

FIG. 7 illustrates a generalized volumetric analysis process for estimation of a composition of fluid from an oil well;

FIG. 8 illustrates an alternative type of fluid volumetric analyzer;

FIG. 9 illustrates a first variation of the fluid volumetric analyzer illustrated in FIG. 8; and

FIG. 10 illustrates a second variation of the fluid volumetric analyzer illustrated in FIG. 8.

### DETAILED DESCRIPTION OF THE INVENTION

Some embodiments of the present invention provide a system and method for determining a level of fluids produced from an oil well automatically, economically, and seamlessly. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### DEFINITIONS

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “fluid mixture” refers to a fluid (gas, liquid, plasma, particulate/granular solid, plastic solid, and other substances that flow in response to an applied shear stress) in which two or more immiscible constituents are physically mixed together but not chemically combined in which the constituents have retained one or more individualized identities or mechanical properties (a constituent may itself be a combination of elements that, in the context of the present invention may be miscible or immiscible). Any constituent may include one or more of a solid, liquid, plasma, and/or gas component, and combinations thereof. Embodiments of the present invention are applicable to different industries, some of which may use the term fluid in slightly different ways requiring this common definition for application in any industry.

Systems and methods are disclosed for an automatic fluid level sensor. The sensor may be used to estimate the level of oil in an oil well. The sensor may also be used in other applications to estimate the level of fluid or the position of a gas/liquid interface in an apparatus. In one or more embodiments, the fluid level sensor is positioned at the wellhead and transmits one or more electrical pulses down the annulus between the tubing and the casing of the oil well. The reflection of the electrical pulse off of the gas/liquid interface, caused by the difference in dielectric constant between the oil and air, is captured by the sensor. The time delay between the original pulse and the reflection is measured, and is proportional to the distance between the well head and the fluid level. The sensor may run a best-fit algorithm on the shape of one or more reflected pulses to measure the time delay to estimate the fluid level. In one or more embodiments, instead of transmitting an electrical pulse, the sensor may transmit a sonic pulse. The reflection of the sonic pulse off of the gas/interface may be captured by a microphone. The speed of the sonic pulse may be estimated based on reflections from joints in the tubing and the known distance between tubing joints. Knowing the speed of the sonic pulse, the sensor may analyze the shape and the time delay of one or more reflected sonic pulses to estimate the fluid level.

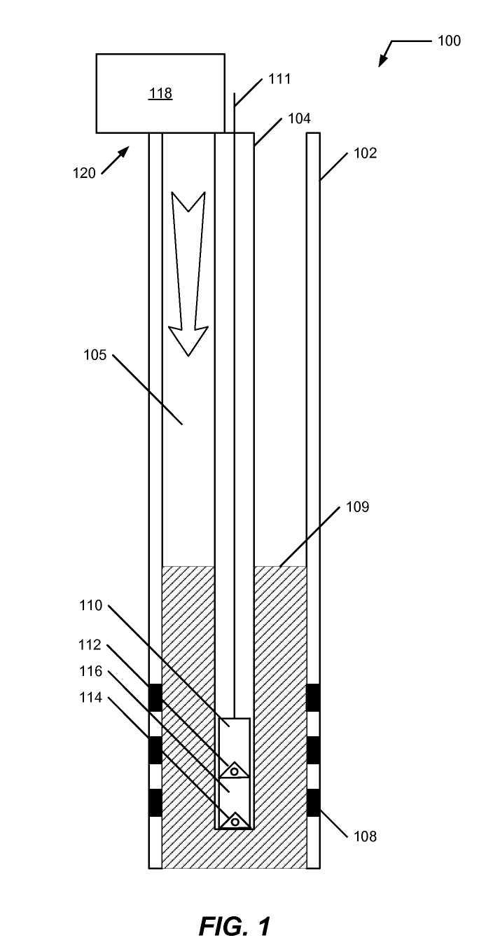

FIG. 1 illustrates a cross sectional view of a down-hole of an oil well 100 that includes a pump and a fluid level sensor at a wellhead to determine a fluid level in the oil well. Oil well 100 includes a casing 102, which is a large metal pipe that runs a length of oil well 100. Enclosed within casing 102 is a tubing 104 that runs to a bottom of the borehole. An annulus 105 forms a space between casing 102 and tubing 104. Oil may enter the borehole through one or more perforations 108 in casing 102 which creates a fluid interface/boundary 109. At a bottom of tubing 104 is a pump that includes a piston 110 attached to a rod 111, a traveling valve 112 at the bottom of piston 110, a standing valve 114 at the bottom of tubing 104, and a pump barrel 116 formed between traveling valve 112 and standing valve 114. As piston 110 and rod 111 lift up, traveling valve 112 is closed. The decrease in pressure in pump barrel 116 sucks oil from the borehole into pump barrel 116 through standing valve 114. As piston 110 and rod 111 push down, standing valve 114 is closed. The increase in pressure in pump barrel 116 pushes oil out from pump barrel 116 through traveling valve 112.

A location of fluid interface 109 in the borehole is a function of the fluid pressure at the bottom of oil well 100 (down-hole pressure). Thus, knowledge of the level of fluid interface 109 in annulus 105 may be used to infer the down-hole pressure of an oil reservoir. As previously mentioned, knowledge of the fluid level is also critical for maximizing production efficiency while minimizing pump wear. A fluid level sensor 118 is placed at a well head 120 to measure the location of fluid interface 109.

In one embodiment, fluid level sensor 118 includes a transmitter, a receiver, and a controller. The transmitter generates one or more electrical pulses and transmits them towards fluid interface 109. The receiver detects one or more reflected signals consequent to the transmitted pulses reflected from fluid interface 109. Fluid level sensor 118 measures a time delay between the transmission of the electrical pulses from well head 120 and a reception of the reflected pulses from fluid interface 109 to estimate a height of the fluid in oil well 100. Casing 102 and tubing 104 of oil well 100 may be electrically isolated with a specified resistance. Fluid level sensor 118 generates an electric pulse or a series of electric pulses. Each electric pulse may be configured to have a transmission profile including a set of parameters such as, for example, a specified rise time, a specified amplitude, a specified pulse interval, and/or a specified fall time. In one or more embodiments, a train of electrical pulses may be configured with a specified spacing between successive pulses or with a specified frequency. The one or more electric pulses travel down the annulus 105 or the coaxial waveguide formed by casing 102 and tubing 104. A time of transmission of the electrical pulses from well head 120 is recorded. A shape of the pulses may include a square wave, a step function, a sinusoidal wave, or other wave form or pulse. The set of parameters including timing parameters and pulse shapes may be selected based on the type of fluid whose height is to be measured. The electrical pulses reflect off of fluid interface 109, for example due to a difference in a dielectric constant between a hydrocarbon fluid and a gas in annulus 105 at fluid interface 109. The reflected pulses travel up the annulus 105 or the coaxial waveguide formed by casing 102 and tubing 104. Fluid level sensor 118 may detect the reflected pulses using a best-fit algorithm on the expected reflection pulses and record their time of reception. A delay between the transmission of the electrical pulses and the reception of the reflected pulses is measured, and is proportional to the distance from well head 120 to fluid interface 109. To minimize a noise in the reflected pulses and any error in the delay measurements, fluid level sensor 118 may run a best-fit algorithm over an average of many reflected pulses or compute an average of the measured delays for a series of pulses.

In one embodiment, fluid level sensor 118 generates one or more sonic pulses instead of electrical pulses. Casing 102 and tubing 104 of the oil well may not be electrically isolated. Similar to the electrical pulses, each sonic pulse may be configured to have a specified rise time, a specified amplitude, a specified pulse interval, and/or a specified fall time. In one or more embodiments, a train of sonic pulses may be configured with a specified spacing or with a specified sonic frequency. The one or more sonic pulses travel down annulus 105 or the coaxial waveguide formed by casing 102 and tubing 104. A speed of the sonic pulses through annulus 105 may be calibrated based on reflections of the sonic pulses from joints in tubing 104 or casing 102 and the known distance between the joints. The sonic pulses also reflect off of fluid interface 109 and travel back up annulus 105 or the coaxial waveguide formed by casing 102 and tubing 104. The reflected sonic pulses may be received by a microphone included as part of the receiver of fluid level sensor 118. Fluid level sensor 118 may run a best-fit algorithm on the signature of the signal received by the microphone to detect the reflected sonic pulses. The time delay between the transmission of the sonic pulses and the reception of the reflected pulses is measured. With knowledge of the speed of the sonic pulses from the speed calibration, fluid level sensor 118 may estimate the distance from the well head to fluid interface 109. To minimize any noise in the reflected pulses and any error in the delay measurements, fluid level sensor 118 may run a best-fit algorithm over an average of many reflected sonic pulses or compute an average of the measured delays for a series of sonic pulses.

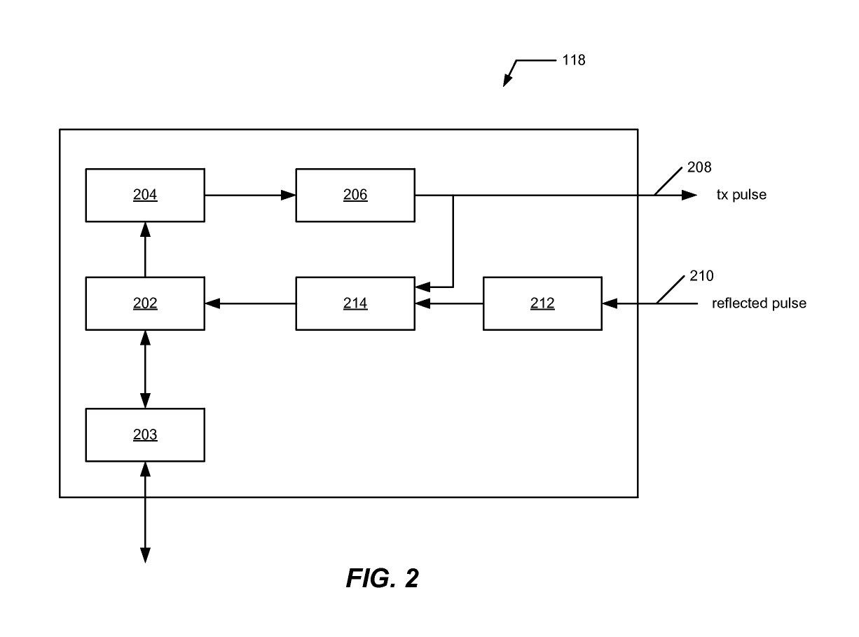

FIG. 2 illustrates a block diagram of fluid level sensor 118. Fluid level sensor 118 includes a controller 202. Controller 202 may be a microcontroller, microprocessor, or other types of processor capable of executing computer readable instructions stored in memories or other types of storage mediums to control the operation of fluid level sensor 118. Controller 202 communicates with a user interface unit 203 to receive commands from and/or transmit information to users through a communication channel. The communication channel may be a wired or wireless channel. For example, user interface unit 203 may receive configuration input specifying the rise time, amplitude, pulse interval, fall time, spacing interval, frequency, pulse shape, number, and the like of the pulses transmitted by fluid level sensor 118.

Controller 202 controls a pulse generator 204 to generate one or more pulses that conform to the input specification. Pulse generator 204 may be a one-shot pulse generator or a fluid lock loop. The pulse transmitted from fluid level sensor 118 may be referred as the transmit pulse 208. A reflection of the TX pulse 208 received by fluid level sensor 118 includes a reflected pulse 210, or may alternatively be referred as the ax pulse. An optional TX filter and amplifier unit 206 may filter and amplify the pulses from pulse generator 204 to perform further waveform shaping of the TX pulse 208 from fluid level sensor 118. A time of transmission of TX pulse 208 is recorded by a delay estimator 214. TX pulse 208 may include an electrical, optical, sonic, hybrid (a combination of one or more of the disclosed modes) or other transmission mode. Reflection of TX pulse 208 is received as reflected pulse 210. When reflected pulse 210 is not an electrical signal, a transducer may be used to convert reflected pulse 210 into an electrical signal. For example, a microphone may be used to convert a sonic pulse into an electrical pulse for subsequent processing. An RX filter and amplifier unit 212 filters and amplifies reflected pulse 210. When the transmission is sonic, a transducer may be necessary to convert an electrical pulse/waveform to a desired set of sonic pulses, the set including one or more pulses. Controller 202 may run a best-fit algorithm on the filtered and amplified reflected pulse with the expected reflection pulse to determine if reflected pulse 210 is a reflection of TX pulse 208. When a reflection is detected, delay estimator 214 may record the time of reception of reflected pulse 210. Delay estimator 204 may measure the time delay between the transmission of TX pulse 208 and the reception of reflected pulse 210. From the measured delay and knowledge of the speed of TX pulse 208 and reflected pulse 210, controller 202 may estimate the distance from fluid level sensor 118 to the point at which TX pulse 208 is reflected.

Controller 202 may output the calculated distance to the reflection point through user interface unit 203. To estimate the speed of TX pulse 208 or reflected pulse 210 through the transmission medium, controller 202 may run a calibration test based on the time delay measurement of reflection of TX pulse 208 from a known distance. In one or more embodiments, reflected signal 210 may be received at a location apart from the location of the transmission of TX pulse 208.

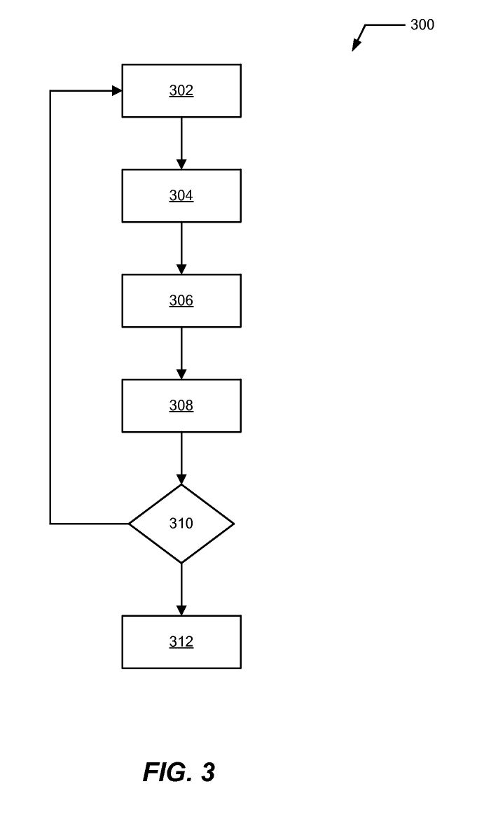

FIG. 3 illustrates an fluid level estimation process 300 including a set of steps 305-312 performed by fluid level sensor 118 to estimate a relative location of fluid level boundary 109 and hence a level of fluid in oil well 100. In 302, fluid level sensor 118 receives configuration parameters for the pulse and configures a TX pulse that conforms to the specification. For example, the TX pulse may be configured to have a specified pulse shape with certain rise time, pulse interval, fall time, and the like. In 304, fluid level sensor 118 transmits the TX pulse down the annulus 105 or the waveguide formed by casing 102 and tubing 104. The TX pulse may be transmitted as an electrical, optical, sonic, or other types of signals. The time of the transmission of the TX pulse may be recorded. When the TX pulse reaches gas/liquid interface 106 the TX pulse may be reflected due to the difference in dielectric, optical, acoustic, or other properties of the gas and liquid on both sides of gas/liquid interface 106. In one or more embodiments, the reflective interface may be an interface between two liquids, two gases, liquid/solid, gas/solid, etc. The reflected pulse travels up the annulus 105 or the waveguide formed by casing 102 and tubing 104.

In 306, fluid level sensor 118 receives the reflected pulse and performs a best-fit algorithm on the signature of the reflected pulse with the expected reflected waveform. Fluid level sensor 118 may declare a detection of the reflected pulse when the correlation between the actual reflected pulse and the expected reflected waveform exceeds a detection threshold. The time of reception of the reflected pulse may be recorded. In 308, fluid level sensor 118 measures the time delay between the transmission of the TX pulse and the reception of the reflected pulse. The time delay is proportional to the distance between fluid level sensor 118 and gas/liquid interface 109. In 310, fluid level sensor 118 determines if there is more TX pulse to transmit. If there is more TX pulse to transmit, 302, 304, 306, and 308 are repeated to measure the time delay between the transmission of the additional TX pulse and the reception of the reflected pulse. In one or more embodiments, a second TX pulse may be transmitted before the reflected pulse from a first TX pulse is received. In 312, when all the TX pulses have been transmitted and all the reflected pulses have been received, fluid level sensor 118 estimates the distance between fluid level sensor 118 and gas/liquid interface 109 from the time delay measurements and the estimated speed of the TX pulse and reflected pulse through the transmission medium. In one or more embodiments, to estimate the speed of the TX pulse or the reflected pulse through the transmission medium, fluid level sensor 118 may run a calibration test based on the time delay measurement of the reflected pulse from a known distance. In one or more embodiments, fluid level sensor 118 may use an average of the time delay measurements to minimize error when estimating the distance to gas/liquid interface 109.

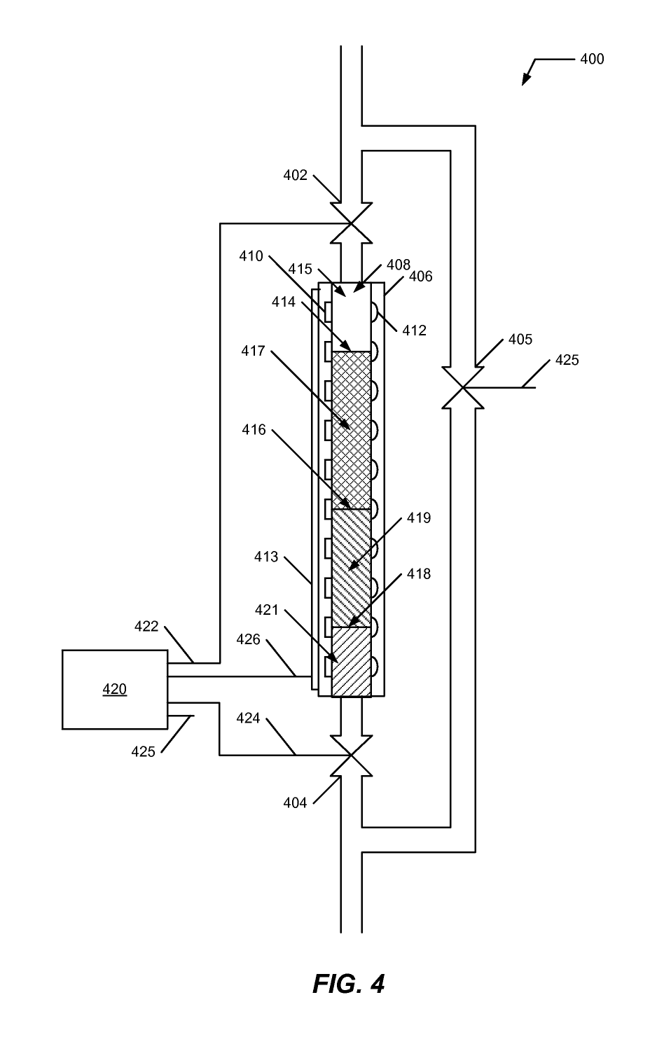

FIG. 4 illustrates a cross sectional view of a cut sensor and a fluid composition analyzer used to determine the composition and the ratio of the components of fluid produced from an oil well in accordance with one embodiment of the present invention. The fluid from an oil well is generally a mixture of oil, water, natural gas, and sediment. The cut sensor includes an inlet valve 402 and an outlet valve 404 located on opposite ends of a central chamber 406, and a bypass valve 405 (for example an inlet port at a top and an outlet port at a bottom of central chamber 406, with other arrangements being possible such as a reversal of the inlet and outlet). Inlet valve 402, outlet valve 404, and bypass valve 405 may be connected to the flow line of an oil well to control the flow of fluid from the oil well into central chamber 406. Central chamber 406 may be oriented vertically to aid in the separation of the constituents of the fluid and may be between 50 cm and 150 cm long. In other embodiments, central chamber 406 may be shorter or longer and may be inclined relative to vertical including a horizontal orientation. When the cut sensor is not operating, inlet valve 402 and outlet valve 404 are open to allow the fluid to flow freely through central chamber 406. Bypass valve 405 may be closed. When a measurement is desired, inlet valve 402 and outlet valve 404 are closed to trap a sample of the fluid in central chamber 406. Bypass valve 405 is open to allow the fluid to flow around central chamber 406. For some embodiments, a “make-before-break” order of operations is implemented to avoid pressure buildup/mechanical rupture. For example, valve 405 is open before 402 and 404 are closed.

Central chamber 406 may be a cylinder, or may take on more complex shape, such as a tapered conical shape or a cylindrical shape with varying radius or cross-section for non-circular implementations of regular or irregular polygons. Sections of smaller radii may be placed in a region where a transition between components is expected. The smaller radii may increase the resolution of the transition to increase the accuracy of the measurement of the ratio of the components in central chamber 406.

A series of light emitting diodes or LEDs 410 running some or all of the length of the inside of central chamber 406 illuminate the inside of central chamber 406. LEDs 410 may emit white light, or light of other frequency or frequencies. The frequencies of emission of any of LEDs 410 may be tuned to the specific absorption bands of the components of the fluid to be measured. The spacing of LEDs 410 may be between 0.25 cm and 2 cm. In other embodiments, the spacing may be more or less than that. In other embodiments, the spacing of LEDs 410 may be irregular. LEDs 410 having various frequencies of emission may also be positioned to optimize measurements of the absorption bands of the components when the ratio of the components of the fluid is approximately known. For example, when the ratio of oil is known to be between 5% and 10%, LEDs 410 tuned to the absorption bands of oil, or to the transition of the absorption bands from oil to another component, may be positioned in the appropriate 5% to 10% length section of central chamber 406 where the oil, or the interface between oil and the other component, is expected to be found after separation of the components of the fluid.

A series of cameras 412 are positioned opposite LEDs 410 to capture the emission of LEDs 410 through the fluid in central chamber 406. Cameras 412 may be sensitive to light of specific frequencies or narrow or wide frequency bands. Cameras 412 may be tuned to capture the spectral bands of emission of LEDs 410 minus the absorption bands of the component illuminated by LEDs 410. Similar to LEDs 410, the series of cameras 412 may run some or all of the length of the inside of central chamber 406. The spacing of cameras 412 may be between 0.25 cm and 2 cm. In other embodiments, the spacing may be more or less than that. In other embodiments, the spacing of cameras 412 may be irregular. Some embodiments include one cameral 412 opposite from each LED 410. Cameras 412 tuned to various frequencies may be positioned to optimize the capture of the emission of LEDs 410 tuned to the specific absorption bands of the components if the ratio of the components of the fluid is approximately known. So in the example where the ratio of oil in the fluid is known to be between 5% and 10%, cameras 412 tuned to the absorption bands of oil may be positioned in the appropriate 5%-10% length section of central chamber 406 where LEDs 410 tuned to the absorption bands of oil are similarly positioned. The density of cameras 412 and LEDs 410 may be adjusted based on the desired accuracy of the measurements of the ratios of the components. More accurate ratio measurements may require cameras 412 and LEDs 410 to be positioned with smaller spacing. In other embodiments, when the ratio of the components of the fluid is approximately known, cameras 412 and LEDs 410 may be more densely positioned along sections of central chamber 406 near the expected positions of the interface between the components of the fluid than in other sections. LEDs 410 and cameras 412 may be separated from the fluid by a barrier made from plastic or glass or another material transparent to the light emitted from LEDs 410. In other embodiments, LEDs 410 and cameras 412 may come in direct contact with the fluid in central chamber 406 or one or more cameras 412 may otherwise be positioned differently with respect to the LEDs 410. For example, a set of one or more of LEDs 410 may be located on a same side of central chamber 406 to measure reflected/backward-emitted radiation from incident radiation directed onto the sample from LEDs 410, or to measure radiated energy from the sample. Some embodiments may use a part of the electromagnetic spectrum for which the sample is sufficiently transparent when using a transmission model (it being possible that transmission of visible radiation through a sample including fluid produced from an oil well may not provide a sufficiently strong signal).

A heating element 413 may run the length of central chamber 406. Heating element 413 may heat the fluid to increase the rate of separation of the components for fluid containing certain components or under certain conditions. For example, for the fluid sample containing certain oil type, heating element 413 may be turned on to heat the fluid to a desired temperature, between 20° C. and 80° C. For fluid containing other type of components or under certain external conditions, heating element 413 may heat the fluid to other temperature range, or may not heat the fluid at all. A pre-defined waiting period, which may be 1, 2, or 3 hours or longer or shorter depending on the oil type, availability of heating element 413, and external conditions, may allow the fluid sample to separate into sediment, water, oil, and gas due to the difference in the density or specific gravity of the components. For example, a fluid sample 408, after the pre-defined waiting period, may separate into gas 415, oil 417, water 419, and sediment 421. The result is the formation of a gas/oil interface 415, oil/water interface 416, and water/sediment interface 418. In one or more embodiments, LEDs 410 and cameras 412 may be used to verify when a desired amount of separation has been achieved instead of, or in conjunction with, waiting for the pre-defined waiting period. For example, the separation may be verified when cameras 412 detect the emission of LEDs 410 absent the absorption bands of oil only in the section of central chamber 417 containing oil 417.

Once the separation of the components of sample 408 has been achieved, cameras 412 may capture the spectral bands of light of LEDs 410 emitted through or by the separated components along the length of central chamber 406. A fluid composition analyzer 420 may analyze the captured emission spectrum to determine the locations of the interfaces between the various components. For example, cameras 412 near gas/oil interface 414 may capture emissions of LEDs 410 that transition from missing the absorption bands of oil 417 to missing the absorption of gas 415. Fluid composition analyzer 410 may receive the captured LED emissions from cameras 412 and information on the positions of cameras 412 through a data channel 426 to determine the locations of gas/oil interface 414, oil/water interface 416, and water/sediment interface 418. From the locations of the interface between the various components, fluid composition analyzer 420 may determine the ratios of the various components of the fluid.

After a measurement is made, inlet valve 402 and outlet valve 404 are opened to flush fluid sample 408 from central chamber 406 into the flow line. Bypass valve 405 may be closed to close the bypass path. Fluid composition analyzer 420 may control inlet valve 402, outlet valve 404, and bypass valve 405 through inlet valve control 422, outlet valve control 424, and bypass valve control 425, respectively. Multiple fluid samples 408 may be trapped for the cut sensor and fluid composition analyzer 420 to take multiple measurements. The multiple measurements may be averaged to reduce the error in the calculated ratios of the various components of the fluid.

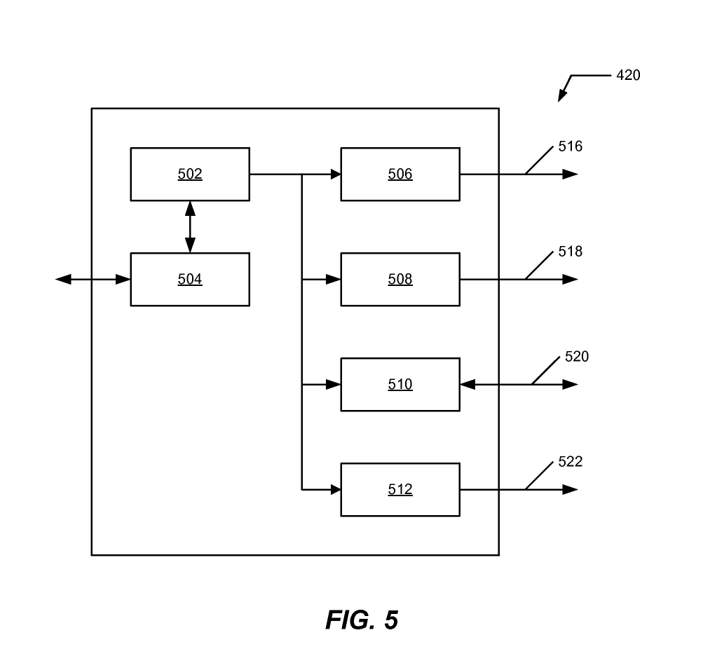

FIG. 5 illustrates a block diagram of fluid composition analyzer 420 of FIG. 4. Fluid composition analyzer 420 includes a controller 502. Controller 502 may be a microcontroller, microprocessor, or other type(s) of stored program processor capable of executing computer readable instructions stored in, and retrieved from, one or more memories or other types of storage medium to control an operation of the cut sensor. Controller 502 communicates with a user interface unit 504 to receive commands from and/or transmit information to users through a communication channel. The communication channel may be a wired or wireless channel. For example, user interface unit 504 may receive commands to tune the frequencies of emission of LEDs 410 to the specific absorption bands of the components of the fluid to be measured.

A valve control interface unit 506 under control of controller 502 opens and closes inlet valve 402, outlet valve 404, and bypass valve 405 to trap or flush fluid samples in central chamber 406 for measurements. Valve control interface 506 controls the valves through a control mechanism 516. A LED control interface unit 508 under the control of controller 502 operates LEDs 410 to emit light of certain frequencies. The frequencies of emission may be tuned to the specific absorption bands of the components of the fluid sample illuminated by LEDs 410. LEDs 410 may be individually controlled through LED control mechanism 518 to optimize detection of the interfaces between the various components of the fluid sample.

A camera interface unit 510 under the control of controller 502 receives the emission of LEDs 410 captured by cameras 412. Camera interface unit 510 may tune cameras 412 to detect the absorption bands of the component illuminated by LEDs 410. The emission spectrum of LEDs 410 captured by cameras 412 may thus show the missing absorption bands when the component is present in, adjacent, or nearby the sample. Camera interface unit 510 may individually control the frequency sensitivity of cameras 412 through camera control line 520 to optimize detection of the interfaces between the various components of the sample.

A heating element control interface unit 512 under the control of controller 502 operates heating element 413 to increase the rate of separation of the components in the fluid sample. Heating element 413 may be turned on for a pre-defined time to heat the fluid sample to a certain temperature range. Heating element 413 may be operated in conjunction with LEDs 410 and cameras 412 to verify that the separation of the components has been achieved. Heating element control interface unit 512 may control heating element 413 through heating element control line 522.

After a measurement is taken, controller 502 may analyze the captured emission spectrum of LEDs 410 from cameras 412 and information on the positions of cameras 412 to determine the locations of the interface between the various components of the fluid sample. Controller 502 may determine from the interface locations the ratios of the various components of the fluid sample. Controller 502 may output the ratio information to users through user interface unit 504.

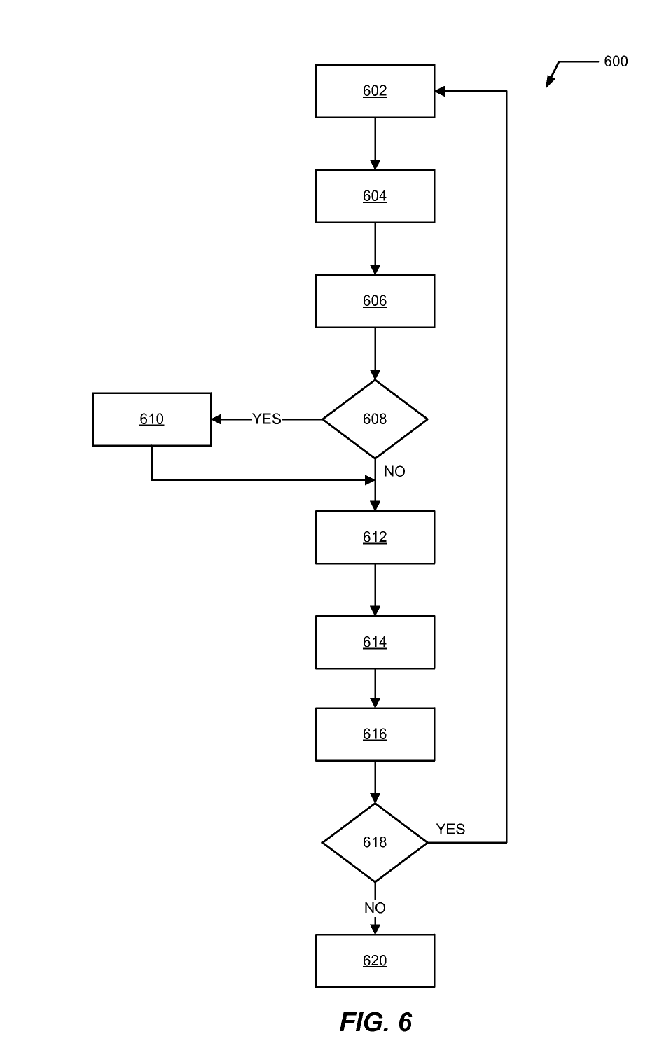

FIG. 6 illustrates an estimation process 600 including a set of steps of operations of the cut sensor and fluid composition analyzer 420 of FIG. 4 to estimate a composition of the fluid produced from one or more oil wells in accordance with one embodiment of the present invention. Process 600 includes step 602-step 620. In an emission configuration step 602, fluid composition analyzer 420 receives configuration parameters for LEDs 410 and configures LEDs 410 to emit frequencies that are tuned to the specific absorption bands of the components of the fluid to be measured. Fluid composition analyzer 420 may also configure the position of LEDs 410 to optimize measurements of the absorption bands of the components when the ratio of the components of the fluid is approximately known. In a sensitivity configuration step 604, fluid composition analyzer 420 receives configuration parameters for cameras 412 and configures cameras 412 to have frequency sensitivities that detect the absorption bands of the component of the fluid illuminated by LEDs 410. Fluid composition analyzer 420 may also configure the positions of cameras 412 to optimize the capture of the emission of LEDs 410 tuned to the specific absorption bands of the components when the ratio of the components of the fluid is approximately known.

In a fluid capture step 606, fluid composition analyzer 420 closes inlet valve 402, closes outlet valve 404, and opens bypass valve 405 (preferably in some implementations opening valve 405 prior to closing valve 402 and valve 404 or have a nearly concurrent opening and closing) to trap a fluid sample in central chamber 406 for measurement. In a temperature test step 608, fluid composition analyzer determines when heating element 413 is to be turned on to increase the rate of separation of the components in the fluid sample. If heating is desired (test at step 608 is TRUE), a heating step 610 in which heating element 413 is turned on for a specified time to heat the fluid sample to a certain temperature range. After the specified heating time of step 610 or if the fluid sample is not to be heated (test at step 608 is FALSE), the fluid sample may be left for a pre-defined waiting period to allow the components in the fluid sample to achieve separation. In an LED trigger step 612, fluid composition analyzer 420 triggers emission of the configured frequencies from LEDs 410 to illuminate the separated components of the fluid sample. In an emission capture step 614, fluid composition analyzer 420 triggers cameras 412 to capture the spectral bands of emission from LEDs emitted through the separated components. The emission spectrum of LEDs 410 captured by cameras 412 may show the missing absorption bands corresponding to a component when the component is present in the fluid sample.

In a fluid sample flush step 616, fluid composition analyzer 420 opens inlet valve 402, opens outlet valve 404, and closes bypass valve 405 to flush the fluid sample from central chamber 406. In a test step 618, if more measurements are desired (test at step 618 is TRUE), process 600 loops back and one or more of steps 602, 604, 606, 608, 610, 612, 614, and 616 may be repeated. When the test at step 618 is FALSE, process 600 performs an estimation step 620, fluid composition analyzer 420 analyzes the captured emission spectrum of LEDs 410 from one or more measurements to estimate the composition of the fluid by determining the locations of the interface(s) between the various components of the fluid as desired.

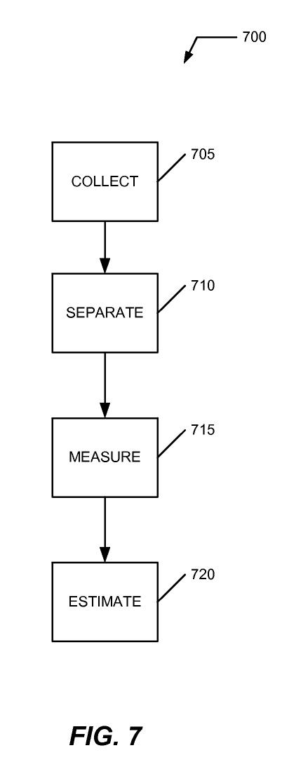

FIG. 7 illustrates a generalized composition analysis process 700 for estimation of a composition of fluid produced from an oil well. Process 700 includes a set of steps, steps 705-720. Process 700 of the disclosed embodiment of the present invention relates to an automated sampling vessel that collects (at a collection step 705) a representative fluid sample from a main-flow line (e.g., a line running between one or more oil wells and a tank farm) of an oil field. The automated sampling vessel isolates the representative fluid sample from the main flow, and retains the sample within a sampling chamber (e.g., a vertical column). At a separation step 710, the sampling vessel may subject the isolated fluid sample to various pre-estimation processes to facilitate separation of the components of the isolated fluid sample over an appropriate period. These pre-processes may include one or more temperature adjustment, pressure adjustment, chemical treatment, mechanical agitation, and/or passage of time. A set of detection elements are coupled to the sample vessel to make various automated measurements at a measurement step 715. From these measurements, estimations may be made of one or more characteristics of the fluid sample at an estimation step 720.

Measurements may include one or more of: temperature of the main flow fluid at the time of collection; pressure of the main fluid flow at the time of collection; and one or more position(s) of one or more interfaces between component layers (after separation)—steam, evolved gas, oil, emulsion, water, and/or solids or sediment.

For many oil field operators, current techniques include manual (per well) collection of a sample in a glass jar which is then placed in a room until it separates. A ruler is used to measure a height of water versus oil to determine a volumetric cut. Some embodiments of the present invention provide an automated measurement of these heights more efficiently and accurately.

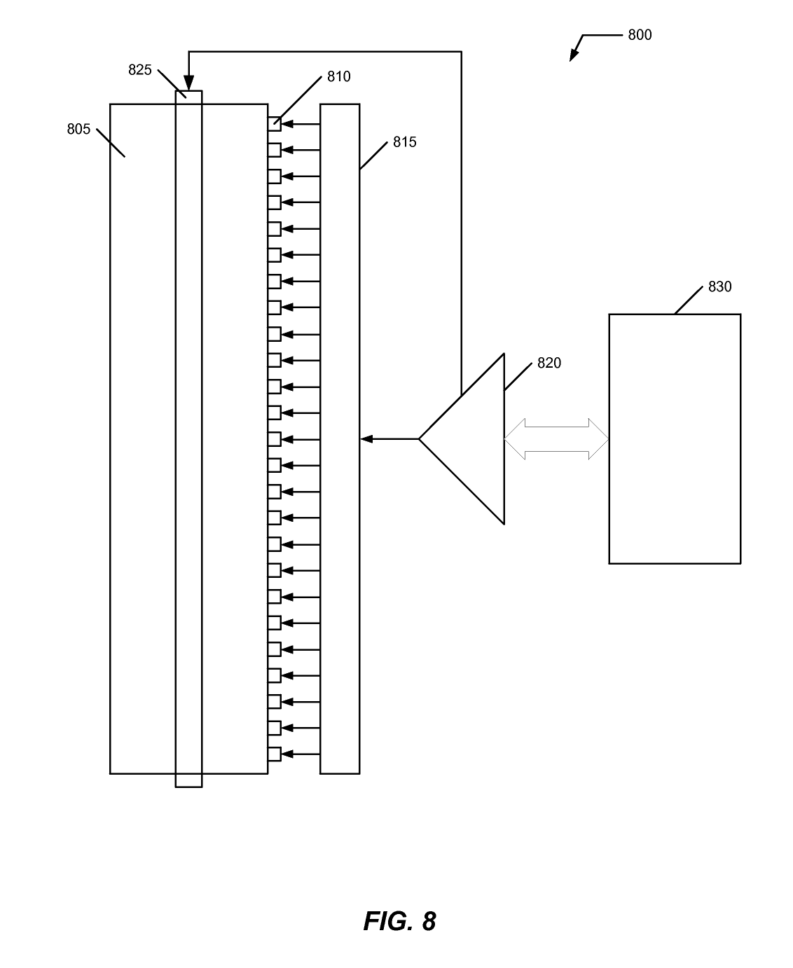

FIG. 8 illustrates an alternative type of fluid composition analyzer 800. Analyzer 800 is designed for use in a sampling and collection environment similar to that illustrated in FIG. 4 in which analyzer 800 is coupled to a fluid sample within a defined sampling chamber 805 (e.g., a length of non-conductive (e.g., non-metal) pipe) that include a set of valves and conduits to selectively direct main line flow. A set of detecting elements 810, for example an array of individual capacitive electrodes, are coupled to a portion of the non-conductive wall along a sampling length over which the interfaces will form. An addressing system 815, for example a set of cascaded multiplexers, creates an array of addressable detecting elements 810. An analog-to-digital converter 820 (e.g., a capacitance-to-digital converter for capacitive detecting elements) is coupled to addressing system 815 to selectively sample a particular one or more detecting element 810. For capacitive electrodes, converter 820 is also coupled to a common central electrode 825. A microprocessor 830 is coupled to converter 820 to implement the addressing and measurement of digital values from one or more individual detecting elements 810.

In some embodiments, temperature and pressure of main flow is measured while full fluid flow is routed through the chamber of analyzer 800. During a period of full flow, an auto-calibration sequence may execute on a set of detection elements to normalize to an arbitrary signature of a parent fluid. The valving system allows a main flow sample to be automatically collected within a sampling chamber to cut and isolate a unit-length slice from the main flow. Simultaneously main flow is returned back to its normal flow path. Flow from a pump is never restricted by the arrangement of valves and flow paths—the valves configured to operate on an open-before-close direct flow path through the valve network.

Further, a starting temperature and pressure of the isolated sample may be immediately collected. The isolated sample may be heated and/or maintained at an elevated temperature (e.g., a period of 1-8 hours) to facilitate separation. In the illustrated embodiment, a passive gravitational system is employed and the chamber is disposed vertically. Mechanical agitation (e.g., stirrer, vibrator, and the like) may be used to enhance the separation. The environment of the chamber may then be further adjusted for measurement, for example, lowering temperature and/or pressure to near ambient.

The addressable detecting array may be used to read various individual values from a set of detecting elements disposed along a desired length of the chamber. Sharp changes in measurements, e.g., a significant change in capacitance value for capacitance detecting elements, typically indicates presence of an fluid component interface at or near the elements indicating the change. Relative detector values of detecting elements near such interfaces may provide sub-pixel resolution.

Detection elements 810 may also be used in some embodiments to provide information about an amount of one or more constituents contained within a separated sample, as well as a dimensional thickness, of any given layer. There are a range of possible sensing elements that may be included in a set of detecting elements, including sensors for transmitted, reflected, and/or radiated electromagnetic radiation, temperature, pressure, capacitive, inductive, chemical, acoustic, sound, vibration, electric current, electric potential, environmental, moisture, flow, fluid/constituent component velocity, force, density, proximity, combinations thereof, and the like. Particularly in a given application for a particular type of fluid, appropriate detecting elements are selected to detect emulsions, entrained liquids or gases in one or more constituent components.

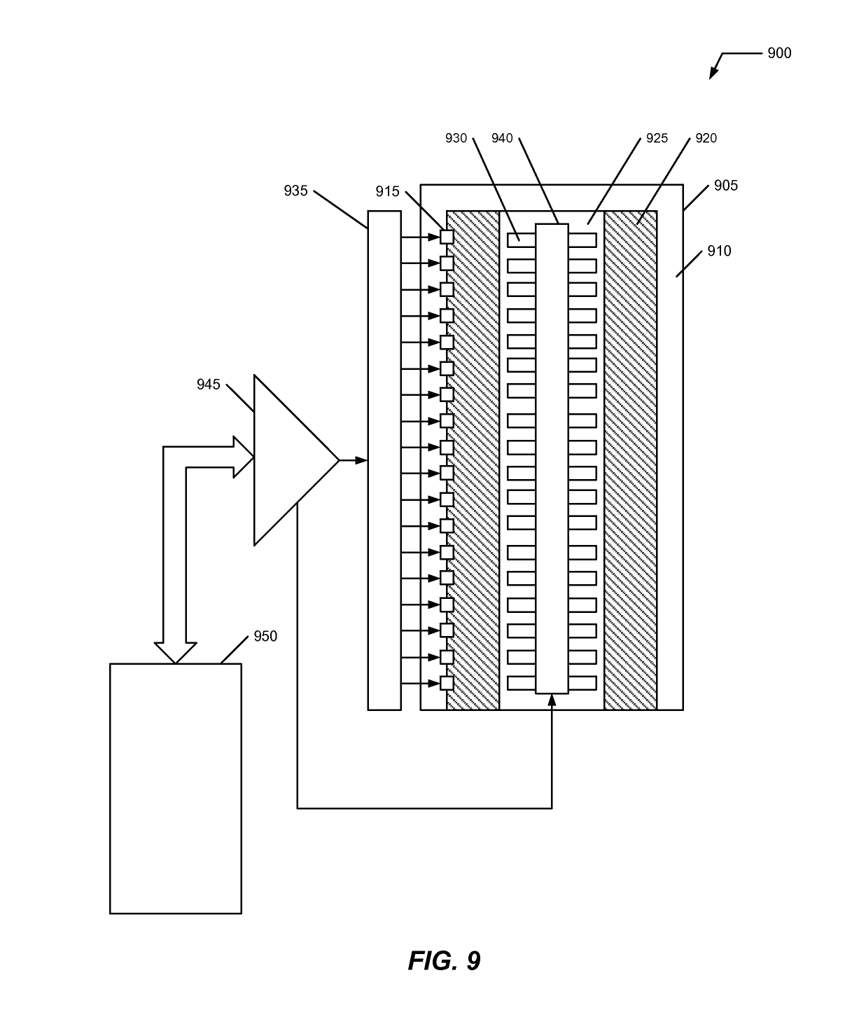

FIG. 9 illustrates a first variation of fluid composition analyzer 900 illustrated in FIG. 8. Analyzer 900 includes an outer metal jacket 905 (e.g., a standard steel pipe such as sch40 (3″ diameter)) that surrounds an outer non-conductive cylindrical circuitry housing 910 that supports a first set of detecting elements 915 (e.g., an array of capacitive electrodes) that operate on a quantity of sample fluid within an annulus 920. An inner non-conductive cylindrical housing 925 is sealed and includes a second set of detecting elements 930 (e.g., an array of capacitive electrodes) paired with first set of detecting elements 915. A first addressing system 935, for example a set of cascaded multiplexers, creates a first array of addressable detecting elements 915. A second addressing system 940 is electrically coupled to second set of detecting elements 930 to create a second array of addressable detecting elements 930. An analog-to-digital converter 945 (e.g., a capacitance-to-digital converter for capacitive detecting elements) is coupled to first addressing system 935 and to second addressing system 940 to selectively sample a particular one or more detecting element 915 against one or more detecting element 930 (for example, selecting individual pairs of paired detecting elements). A microprocessor 950 is coupled to converter 945 to implement the addressing and measurement of digital values between one or more individual detecting elements 915 and one or more individual detecting elements 930.

In some implementations, paired detecting elements may be disposed on rolled flex circuits that are installed in analyzer 900. For example, a first flex circuit with first set detecting elements 915 may be installed on an outside wall of outer housing 910 and a second flex circuit with second set of detecting elements 930 installed inside inner housing 925 (the flex circuits may additionally include corresponding associated addressing systems).

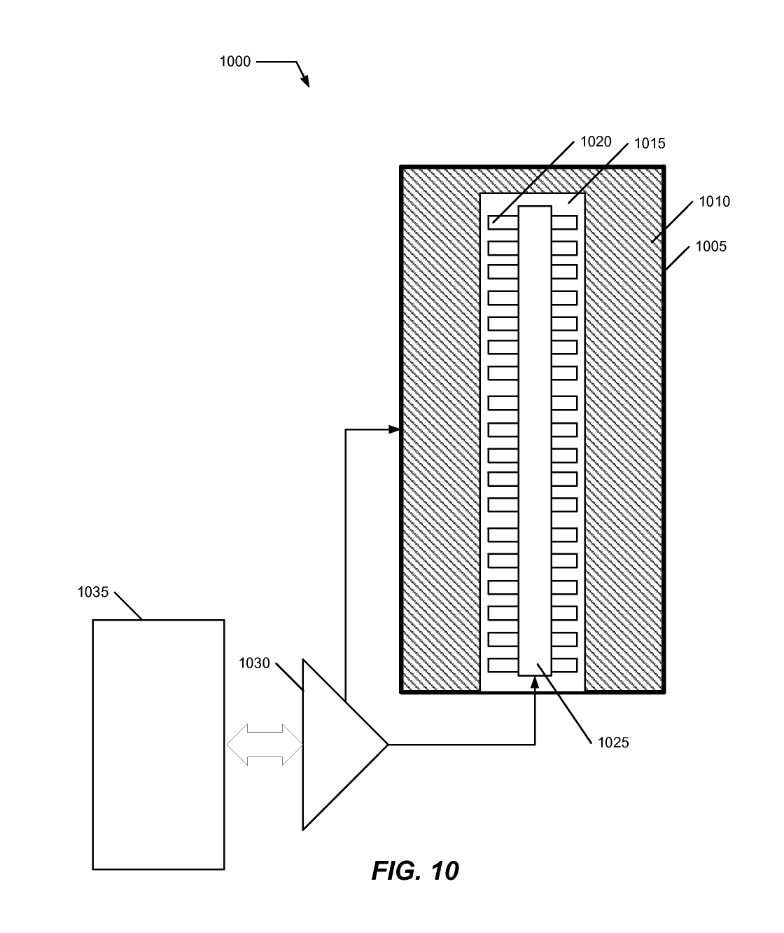

FIG. 10 illustrates a second variation of fluid composition analyzer 1000 illustrated in FIG. 8. Analyzer 1000 includes an outer conductive jacket 1005 that serves as a common electrode (e.g., a standard steel pipe such as sch40 (3″ diameter)) that surrounds a fluid sample in an annulus 1010. An inner non-conductive housing 1015 (e.g., a standard chlorinated polyvinyl chloride pipe (CPVC 2″ diameter)) supports a set of detecting elements 1020 (e.g., individual capacitive electrodes on a rolled flex circuit).

An addressing system 1025, for example a set of cascaded multiplexers, creates an array of addressable detecting elements 1020. An analog-to-digital converter 1030 (e.g., a capacitance-to-digital converter for capacitive detecting elements) is coupled to addressing system 1025 to selectively sample a particular one or more detecting element 1020. For capacitive electrodes, converter 1030 is also coupled to a common electrode 1005. A microprocessor 1035 is coupled to converter 1030 to implement the addressing and measurement of digital values from one or more individual detecting elements 1020.

In some embodiments, a knowledge of temperature and pressure within analyzer 800 at any given time allows calculation of evolved gas, dissolved gas, and/or steam content of the isolated fluid sample.

Some implementations include a gas module in association with chamber 805 that allows pressure control within chamber 805. For example, such a module may allow pressure relief down to atmospheric pressure to measure an amount of evolved gas that will be present at field holding tanks downstream from the main flow line. In some instances, a variety of sensors or sensing systems may be included, such as use of a hydrogen sulfide (H₂S) sensor.

In some embodiments, composition analyzer operates over a range of environmental conditions. For example, the fluid sample may exceed 250 degrees Fahrenheit and electronics in a vicinity are appropriately rated. Ambient temperatures surrounding the cut sensor may be below zero (e.g., −40 degrees Fahrenheit) providing a wide operating temperature range. Temperature may change rapidly, for example, +/−40° F. over 20 seconds.

Fluid pressure inside a sample chamber may exceed 150 psi with a likelihood that electronics proximate the fluid sample will experience some elevated pressures. Preferably the sample fluid under test remains mechanically isolated from the electronics unless special precautions are in place.

Materials in the fluid sample may be corrosive further requiring special considerations for isolation and operation.

Some embodiments may include modules or components to alter and/or manage one or more of the environmental parameters. For example, some embodiments include a temperature control of static fluid in the sample chamber. In some cases, temperature may be varied from ambient to 100° C., with +/−5° C. resolution.

For detecting elements that employ capacitive electrodes, the composition analyzer uses capacitive sensing. A fluid sample is put under test by sensing capacitance between an electrode and either a common ground or a paired capacitive electrode with the sample performing as a dielectric. The value of the capacitance is related to the dielectric, and different constituents of the fluid sample, e.g., when the sample is separated, may be detected by the capacitance profile along the length of the chamber containing the sample.

Illustrated embodiments rely on gravitational separation and hence the detecting elements produce the capacitance profile over the length. While not all embodiments will be so constructed, in the illustrated embodiments each capacitive electrode are of uniform height (preferably no more than 1 cm in height) with minimal spacing between adjacent electrodes. Some implementations may find that electrodes having smaller heights may produce more favorable resolution. Specific dimensions and spacing, as well as other parameters, will balance the number and position of the electrodes against the desired vertical measurement resolution.

The specifics of the testing reflect the nature of the fluid under test. For example, for oil from an oil well of an oil field, primary fluids include natural gas/air (dielectric ∈≈1), crude oil (∈≈2), and polluted water (∈≈20-80). Some embodiments of the present invention may rely upon the concept of frequency-dependent relative permittivity for analyzing the fluid sample based upon the value as a static property or as a frequency-dependent variant.

Some embodiments of the present invention size the geometry of the capacitive electrodes to provide an appropriate base unit of capacitance (∈≈1 with air as the dielectric). Further considerations may include:
Capacitance measurements may be preferred to have a dynamic range of 80x (∈≈80 for water) times the minimum capacitance value (air).
Capacitance measurements are, in the anticipated application of a cut sensor for oil well fluid samples, preferred to have sufficient resolution to efficiently discern between 1x (∈≈1 for air) and 2x (∈≈2 for oil).
Capacitance measurements over the length of the sample may be performed sequentially over a span of several minutes when speed is not a critical factor.
Capacitance measurements over the length of the sample may be performed in parallel in response to a trigger when speed is a critical factor.
Capacitance measurements may be made on fluid samples at a known temperature (Temperature compensation may be employed when necessary/desirable—some instances may perform measurement at ambient and others at a temperature different from ambient (e.g., an elevated temperature).)
Capacitance measurements may be made at relatively low frequencies (e.g., <1 kHz) or radiofrequency (e.g., 3 kHz to 300 GHz).

Some embodiments of the present invention may include the detecting elements formed around a perimeter (e.g., a circle for a cylindrical sample chamber) of a non-conducting tube. The detecting elements may be made available on a flexible substrate (e.g., a polyimide film). Designs are preferred that maintain trace lengths between sensing electronics and electrodes as short as possible to maintain stray capacitance effects to a minimum. Further, in some implementations, relevant capacitance-sensing circuitry is placed on the same flexible substrate as the detecting electrodes. For many of the illustrated implementations, connections leaving a flex circuit pass through one or more sealed walls.

Electrode array configuration may be tuned to the particular application. For some embodiments, it may be preferred to orient the array of detecting elements in such a way that a bulk of an electric field of a detecting element passes through the fluid under test. Preferably there are no conductive surfaces between terminals of any capacitive element of the capacitive array.

As illustrated herein, for a composition analyzer including a capacitive array as part of its detecting system, there may be at least four array configurations (with differing levels of mechanical complexity in implementation):
1. The detector array circuitry is housed in a sealed, non-metal, concentrically mounted inner core, with outer steel tubing serving as a large common electrode. Fluid under test flows in an annulus between the inner core and the outer tube.
2. The detector array circuitry is wrapped around outside of a non-metal tube. A common electrode (e.g., a metal rod [plus any desire heating element]) runs up a center of a non-metal tube. Fluid under test flows in an annulus between the common electrode and the non-metal tube. A preferred implementation may further use an outer steel jacketing (e.g., a standard steel pipe) to provide blow-out protection and electrical shielding.
3. Capacitance measurements are made between electrodes on two separate arrays, the electrodes of the arrays being paired. For example, multiple arrays are printed on same flexible substrate, and wrapped around outside of non-metal tube, through which fluid flows. This may require an outer steel jacketing (standard steel pipe) to provide blow-out protection and electrical shielding. Some implementations may further desire an introduction of a heating element, to control a temperature of the sample fluid. Such an implementation may be similar to the variant illustrated in FIG. 9, without a concentric inner rod or core, and provides the two paired arrays of electrodes on the outside perimeter of the chamber, with the electric field between the paired electrodes passing through the material under test in an asymmetric, irregular manner. This construction is much simpler, but the analysis needed to account for the odd electric field geometry may be more complicated. From the top, this electrode configuration would appear like a circle made up of two non-connected half-circles. The two half-circles would represent the two paired array elements.
4. Capacitance measurements are made between electrodes on two separate paired arrays. One array is housed in a sealed, non-metal, concentrically mounted “pill,” and the other array is wrapped around an outside of a non-metal tube, through which fluid flows. Fluid under test flows in an annulus between the non-metal pill and the non-metal tube. This may require an outer steel jacketing (standard steel pipe) to provide blow-out protection and electrical shielding and/or an introduction of a heating element, to control temperature of the fluid sample.

The system and methods above has been described in general terms as an aid to understanding details of preferred embodiments of the present invention. In the description herein, numerous specific details are provided, such as examples of components and/or methods, to provide a thorough understanding of embodiments of the present invention. While some embodiments of a fluid composition sensor are illustrated as including a vertical elongate chamber having an inlet port at a top and an outlet port at a bottom and a detecting array therebetween, there are a range of possible implementations. For example, the chamber may be constructed with the inlet and outlet ports at “T” junctions emerging from a side of the elongate chamber (detecting array coupled to a portion of the chamber containing the separated constituents), among other possible arrangements. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A fluid mixture sensor, comprising:
an elongate tubular chamber having a first port, a second port, and a first sidewall extending between said ports wherein said first port defines a first opening, said second port defines a second opening, and said first sidewall defines a sample volume capturing a sample of a fluid mixture including a first constituent and a second constituent, said chamber configured to separate said fluid mixture into said constituents and produce a first interface between said first constituent and said second constituent after said separation of said fluid mixture into said constituents;
a plurality of detecting elements disposed along said first sidewall accessing said sample volume, each said detecting element having a first response to said first constituent and having a second response to said second constituent, said second response different from said first response; and
a controller, coupled to said plurality of detecting elements and responsive to said responses, locating a first distance of said first interface from a particular one of said ports.

2. The fluid composition sensor of claim 1 wherein said fluid mixture includes a third constituent, wherein said chamber produces a second interface between said third constituent and one of said first constituent and said second constituent, wherein each said detecting element includes a third response to said third constituent, said third response different from said first response and different from said second response, and wherein said controller locates a second distance of said second interface from said particular one port.

3. The fluid composition sensor of claim 1 wherein said first sidewall includes a non-electrically conductive outer sidewall, wherein each said detecting element of said plurality of detecting elements includes a capacitive electrode coupled to said outer sidewall and further comprising a common electrode disposed within said sample volume and capacitively coupled to each said capacitive electrode with said common electrode extending between said ports.

4. The fluid composition sensor of claim 2 wherein said first sidewall includes a non-electrically conductive outer sidewall, wherein each said detecting element of said plurality of detecting elements includes a capacitive electrode coupled to said outer sidewall and further comprising a common electrode disposed within said sample volume and capacitively coupled to each said capacitive electrode with said common electrode extending between said ports.

5. The fluid composition sensor of claim 1 wherein said first sidewall includes a non-electrically conductive outer sidewall, wherein said plurality of detecting elements include a first set of detecting elements and a second set of detecting elements paired with said first set of detecting elements, each said detecting element of said first set of detecting elements includes a capacitive electrode coupled to said outer sidewall, and further comprising a second sidewall including a non-electrically conductive inner sidewall disposed within said sample volume and extending from said first end to said second end wherein each said detecting element of said second set of detecting elements includes a capacitive electrode coupled to said inner sidewall.

6. The fluid composition sensor of claim 2 wherein said first sidewall includes a non-electrically conductive outer sidewall, wherein said plurality of detecting elements include a first set of detecting elements and a second set of detecting elements paired with said first set of detecting elements, each said detecting element of said first set of detecting elements includes a capacitive electrode coupled to said outer sidewall, and further comprising a second sidewall including a non-electrically conductive inner sidewall disposed within said sample volume and extending from said first end to said second end wherein each said detecting element of said second set of detecting elements includes a capacitive electrode coupled to said inner sidewall.

7. The fluid composition sensor of claim 5 further comprising an outer steel jacket surrounding said first sidewall.

8. The fluid composition sensor of claim 6 further comprising an outer steel jacket surrounding said first sidewall.

9. The fluid composition sensor of claim 1 wherein said first sidewall includes a non-electrically conductive inner sidewall, wherein each said detecting element of said plurality of detecting elements includes a capacitive electrode coupled to said inner sidewall and further comprising a common outer electrode disposed around said sample volume and extending between said ports.

10. The fluid composition sensor of claim 2 wherein said first sidewall includes a non-electrically conductive inner sidewall, wherein each said detecting element of said plurality of detecting elements includes a capacitive electrode coupled to said inner sidewall and further comprising a common outer electrode disposed around said sample volume and extending between said ports.

11. A fluid composition sensor, comprising:
a chamber adapted to capture a sample of a fluid mixture that includes a plurality of constituents;
a plurality of light-emitting diode (LEDs) placed along the length of the chamber, wherein the LEDs are configured to emit a light of one or more frequencies toward the sample of said fluid;
a plurality of cameras paired with and said plurality of LEDs and disposed along the length of the chamber, wherein the cameras are configured to capture the one or more frequencies of the light emitted by the LEDs acted upon by the sample of said fluid; and
an analyzer adapted to analyze the frequencies of the light emitted by the LEDs and captured by the cameras to determine a boundary between two of the components of the sample of said fluid.

12. An automated method of analyzing a fluid mixture having a plurality of constituents using a processor-controlled analyzer, comprising:
a) capturing a sample of the fluid mixture within an elongate tubular chamber of the processor-controlled analyzer, said elongate tubular chamber having a first port, a second port, and a first sidewall extending between said ports wherein said first port defines a first opening, said second port defines a second opening, and said first sidewall defines a sample volume capturing said sample including a first constituent and a second constituent;
b) separating said sample into said constituents to produce a first interface between said first constituent and said second constituent;
c) accessing said sample volume with a plurality of detecting elements disposed along said first sidewall, each said detecting element having a first response to said first constituent and having a second response to said second constituent, said second response different from said first response; and
d) locating, responsive to said responses and using a processor executing instructions retrieved from a memory, a first distance of said first interface from a particular one of said ports.

13. The automated method of claim 12 wherein said sample includes a third constituent, wherein said separating step b) produces a second interface between said third constituent and one of said first constituent and said second constituent, wherein each said detecting element includes a third response to said third constituent, said third response different from said first response and different from said second response, and wherein said locating step d) locates a second distance of said second interface from said particular one port.

14. The automated method of claim 12 wherein said accessing step c) produces a response profile concurrently from each said detecting element.

15. The automated method of claim 13 wherein said accessing step c) produces a response profile concurrently from each said detecting element.

16. The automated method of claim 12 wherein said accessing step c) produces a response profile serially from each said detecting element.

17. The automated method of claim 13 wherein said accessing step c) produces a response profile serially from each said detecting element.

18. The automated method of claim 12 wherein said plurality of detecting elements includes a set of capacitive electrodes.

19. The automated method of claim 12 wherein said first sidewall includes a non-electrically conductive outer sidewall, wherein each said detecting element of said plurality of detecting elements includes a capacitive electrode coupled to said outer sidewall and further comprising a common central electrode disposed within said sample volume and extending between said ports.

20. A fluid mixture composition sensor, comprising:
an elongate tubular chamber having a first port, a second port, and a first sidewall extending between said ports wherein said first port defines a first opening, said second port defines a second opening, and said first sidewall defines a sample volume capturing a sample of a fluid mixture including a first constituent and a second constituent, said chamber configured to separate said fluid mixture into said constituents and produce a first interface between said first constituent and said second constituent after said separation of said fluid mixture into said constituents;
a plurality of detecting elements disposed along said first sidewall accessing said sample volume, each said detecting element having a first response to said first constituent and having a second response to said second constituent, said second response different from said first response; and
a controller, coupled to said plurality of detecting elements and responsive to said responses, determining a first composition of said first constituent and determining a second composition of said second constituent.
